(19) United States
(12) Patent Application Publication
(10) Pub. No.: US 2014/0250523 A1
(43) Pub. Date: Sep. 4, 2014

(54) Continuous Authentication, and Methods, Systems, and Software Therefor

(71) Applicant: Carnegie Mellon University, Pittsburgh, PA (US)

(72) Inventors: Marios Savvides, Pittsburgh, PA (US); Aaron Jaech, Seattle, WA (US)

(21) Appl. No.: 14/052,200

(22) Filed: Oct. 11, 2013

Related U.S. Application Data
(60) Provisional application No. 61/795,172, filed on Oct. 11, 2012.

(51) Int. Cl. G06F 21/32; G06F 21/36

(52) U.S. Cl. CPC G06F 21/32; G06F 21/36
USPC 726/19

(57) ABSTRACT

Controlling a registered-user session of a registered user on a device using first and second authentication processes and a handoff from the first process to the second process. In one embodiment, the first authentication process is a stronger process performed at the outset of a session, and the second authentication process is a weaker process iteratively performed during the session. The stronger authentication process may require cooperation from the user, while the weaker authentication process is preferably one that requires little or no user cooperation. In other embodiments, a strong authentication process may be iteratively performed during the session.

### RELATED APPLICATION DATA

This application claims the benefit of priority of U.S. Provisional Patent Application Ser. No. 61/795,172, filed on Oct. 11, 2012, and titled “Methods and Systems for Continuous Biometric Authentication”, which is incorporated by reference herein in its entirety.

### STATEMENT OF GOVERNMENT INTEREST

Subject matter of this disclosure was made with government support under Army Research Office grants DAAD19-02-1-0389 and W911NF-09-1-0273. The government may have certain rights in this subject matter.

### FIELD OF THE INVENTION

The present invention generally relates to the field of access control. In particular, the present invention is directed to continuous (or iterative) user authentication, and methods, systems, and software therefor.

### BACKGROUND

Access control methods often rely on a single authentication step, requiring a password or physical token to verify a user's identity; however, such methods can often be compromised relatively easily. For example, passwords can be discovered through brute-force attacks, keystroke loggers, or social engineering, while physical tokens can be stolen or reverse-engineered. In light of these shortcomings, researchers have been developing biometric systems capable of identifying a user based on physical characteristics, such as their face, iris, or fingerprint, which can be analyzed to present a significantly higher bar to unauthorized users than passwords or physical tokens. For example, a user's iris or fingerprint can be analyzed to implement accurate, robust access control methods, but such methods typically require a user to place their finger on a fingerprint sensor or to position their face a certain distance from a camera to ensure suitable-quality iris acquisition, which can be inconvenient. On the other hand, face recognition can be used to identify an individual without requiring user cooperation, but modern face recognition methods do not offer the same level of robustness and accuracy as iris and fingerprint analysis. Accordingly, new methods and systems for controlling access are needed.

### SUMMARY OF THE DISCLOSURE

It is understood that the scope of the present invention is limited to the scope provided by the independent claims, and it is also understood that the scope of the present invention is not limited to: (i) the dependent claims, (ii) the detailed description of the non-limiting embodiments, (iii) the summary, (iv) the abstract, and/or (v) description provided outside of this document (that is, outside of the instant application as filed, as prosecuted, and/or as granted).

In one implementation, the present disclosure is directed to a method of controlling a registered-user session of a registered user, wherein the registered-user session is conducted on a device, the method being performed by an authentication system. The method includes performing a first authentication process so as to authenticate the registered user, wherein the first authentication process has a first basis and includes: receiving first identifying data associated with the registered user; and comparing the first identifying data to first authenticated data so as to determine whether a match exists between the first identifying data and the first authenticated data. If a match is determined to exist based on said comparing, then the method includes handing off authentication to a second authentication process having a second basis different from the first basis; iteratively generating an authentication status indicating whether or not the registered user remains present at the device; and controlling the session as a function of the authentication status.

In another implementation, the present disclosure is directed to a machine-readable storage medium containing machine executable instructions for performing a method of controlling a registered-user session of a registered user, wherein the registered-user session is conducted on a device. The machine-executable instructions include a first set of machine-executable instructions for performing a first authentication process so as to authenticate the registered user, wherein the first authentication process has a first basis and said first set of machine-executable instructions includes machine-executable instructions for: receiving first identifying data associated with the registered user; and comparing the first identifying data to first authenticated data so as to determine whether a match exists between the first identifying data and the first authenticated data. The machine-executable instructions further include a second set of machine-executable instructions for determining whether a match exists based on said comparing, and, if a match is determined to exist, for: handing off authentication to a second authentication process having a second basis different from the first basis; iteratively generating an authentication status indicating whether or not the registered user remains present at the device; and controlling the session as a function of the authentication status.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a flow diagram illustrating a method of controlling a registered-user session of a registered user;

FIG. 2 is a high-level block diagram of a feature-matching system made in accordance with the present disclosure; and

FIG. 3 is a diagram illustrating a computing system that can implement methods of the present disclosure and/or various portions of such methods.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to methods and software that include steps and/or machine-executable instructions for controlling a registered-user session of a registered user on a device. The present inventors have discovered that security of registered-user sessions on devices can be greatly improved by performing continuous authentication in accordance with one or more embodiments of the present disclosure. In one embodiment, a strong authentication process is performed at the outset of a session and a weaker authentication process is iteratively performed during the session. The strong authentication process will typically require cooperation from the user, while the weaker authentication process is preferably one that requires little or no user cooperation. In other embodiments, a strong authentication process may be iteratively performed during the session.

Before proceeding with describing the numerous aspects of the present invention in detail, a number of definitions of certain terms used throughout this disclosure, including the appended claims, are first presented. These terms shall have the following meanings throughout unless noted otherwise. Like terms, such as differing parts of speech, differing tenses, singulars, plurals, etc., for the same term (e.g., placing, place, placement, placements, placed, etc.) shall have commensurate meanings.

Device: A “device” can be a laptop, workstation, tablet, automobile, weapon, or any other system, apparatus, or computing device that can implement or be made to implement one or more registered-user sessions.

Registered user: A “registered user” is a person who has been pre-authorized to use the device.

Registered-user session: A “registered-user session” is a time period during which a registered user uses a device after authentication. For example, in the context of a computer, this can be a period during which a user is logged on. For an automobile or other device, it can be the period during which one or more particular functions of the device can be accessed by a user.

Basis: A “basis” is a type and/or strength of authentication, such as fingerprint analysis, retina analysis, hand-scan analysis, face comparison analysis, keystroke-pattern analysis, and/or voice recognition, among others. For example, face comparison based on a high-quality image of a face located a predetermined distance from and facing directly at a camera can be considered to be one basis, while face recognition based on a low-quality image of a face located at an unknown distance from and not necessarily facing a camera can be considered to be a second, different basis. A basis may include multiple bases.

Identifying data: “Identifying data” is data representing one or more characteristics of a user that can be used to identify that user. Identifying data can be fingerprint-scan data, retina-scan data, hand-scan data, face image data, keystroke-pattern data, or voice data, among others.

Authenticated data: “Authenticated data” is identifying data that is known, for example, from prior authentication, to be uniquely linked to a particular registered user. For example, in a fingerprint-scan context, the authenticated data is fingerprint-scan data known to be obtained from the registered user.

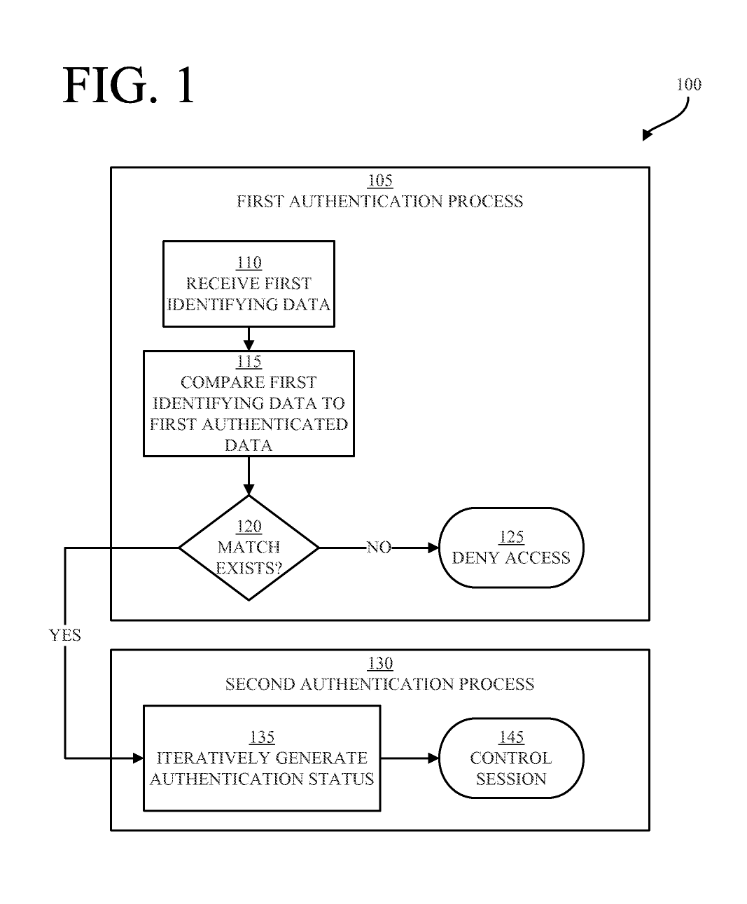

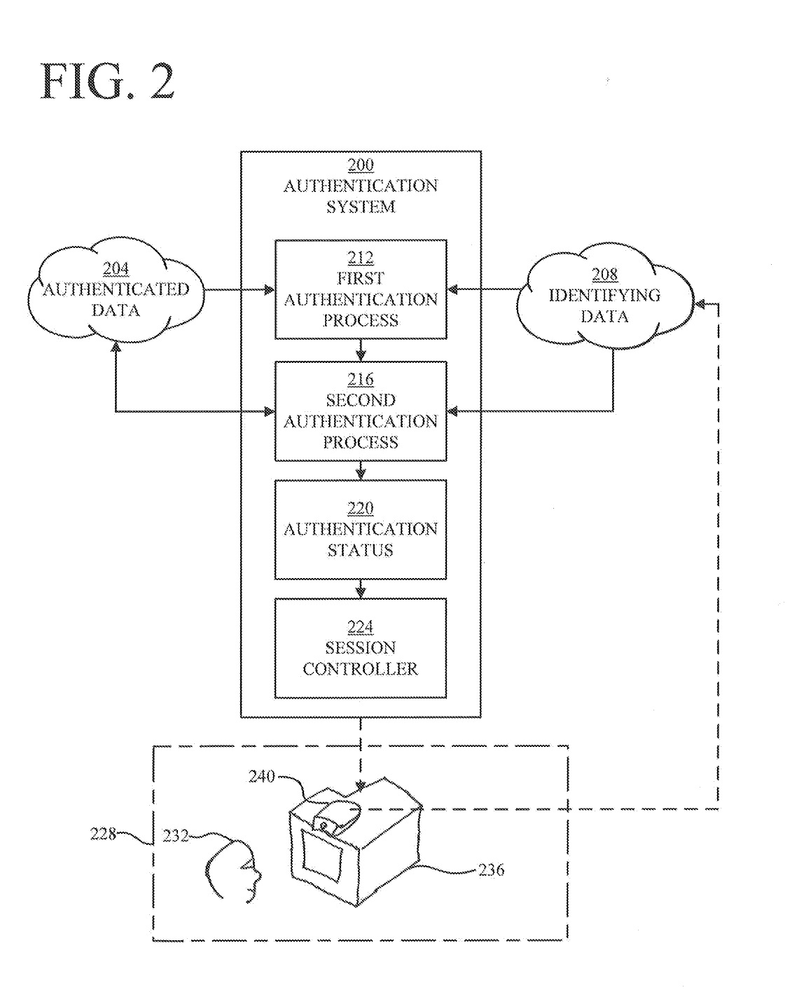

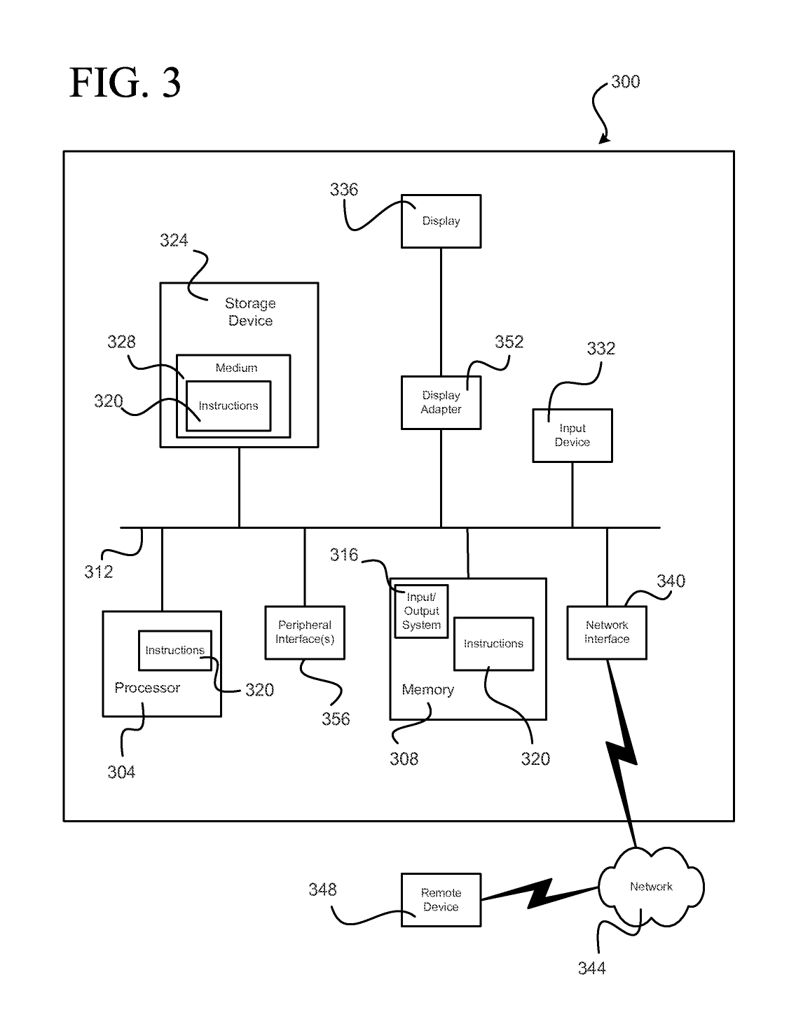

Referring now to the drawings, FIG. 1 illustrates an exemplary method 100 of controlling a registered-user session of a registered user on a device. A first authentication process 105 proceeds by, at step 110, receiving first identifying data associated with a registered user at an authentication system, which may be any one or computing devices that generally are: 1) programmed with instructions for performing steps of a method of the present disclosure; 2) capable of receiving and/or storing data necessary to execute such steps; and 3) capable of providing any user interface that may be needed for a user to interact with the system, including setting up the system for a registered-user session, among other things. Those skilled in the art will readily appreciate that an authentication system of the present disclosure can be implemented on a self-contained device, such as a smartphone, tablet computer, laptop computer, desktop computer, sever, or web-server, or on a network of two or more of any of these devices. Fundamentally, there is not limitation on the physical construct of the authentication system, as long as it can provided the features and functionality described herein. FIGS. 2 and 3, described more fully below, illustrate exemplary systems 200, 300 that can be used to implement various steps of method 100 or any other method incorporating features/functionality disclosed herein. For example, method 100 may be performed by an authentication system 200 that may control a registered-user session on a device as a function of authenticated data 204 and identifying data 208.

For convenience, method 100 is described in the context of system 200. However, those skilled in the art will readily appreciate that method 100 has applications in many other contexts, such as the contexts noted herein, among others. Unless noted otherwise, the following description makes references to FIGS. 1 and 2, and which figure is at issue can be determined from the first digit of the reference numerals, as FIG. 1 uses 100-series numerals and FIG. 2 uses 200-series numerals.

Referring now to FIGS. 1 and 2, the first identifying data received at step 110 may represent one or more biometric characteristics of a user attempting to gain access to a device, and system 200 may acquire this data at the time that the user is attempting to gain access. For example, the first identifying data may include a contemporaneous image of the user or a representation derived therefrom (e.g., a quality image of the user's iris). The first authenticated data, on the other hand, may include a like image that has been pre-authenticated for the purported registered user if the user must identify her- or himself by name or otherwise, or, if the user does not make an initial identification, the first authenticated data may include a plurality of like images corresponding to all authorized users or representations derived therefrom. Acquiring first identifying data may require the user to cooperate to some degree, for example, by applying their finger or hand to an appropriate sensor or placing their eye at an acceptable distance from a camera for their iris to be acquired. First authentication process 212 of authentication system 200 of FIG. 2 may perform step 110.

Those skilled in the art will readily appreciate that the identifying data will typically be utilized by method 100 in the form of digital data, for example, fingerprint-scan data, retina-scan data, hand-scan data, face image data, keystroke-pattern data, or voice data, among others, stored in a suitable file format or container. System 200 may obtain authenticated data 204 from a database, through the Internet, and/or in any other manner known in the art suitable for providing authenticated data, and any combination thereof. System 200 may obtain identifying data 208 by means of a camera or other optical scanner, microphone, fingerprint reader, hand scanner, keyboard, or any other manner known in the art to be suitable for obtaining identifying data from a user, for example, from a component of the device to which the user is attempting to gain access or from a device on the same network as the device, such as, for example, a security camera or remote microphone. It is important to note that although FIG. 2 represents authenticated data 204 and identifying data 208 as being outside of authentication system 200 in FIG. 2, authentication system 200 may store authenticated data 204 and/or identifying data 208 using an appropriate computer storage system (see, e.g., FIG. 3).

At step 115, first authentication process 105 compares first identifying data, such as identifying data 208 of FIG. 2, to first authenticated data, such as authenticated data 204 of FIG. 2, in order to determine whether a match exists between the first identifying data and the first authenticated data. This comparison may include comparisons on the bases of fingerprint-scan data, retina-scan data, hand-scan data, face image data, keystroke-pattern data, and/or voice data, among others. In an exemplary embodiment, first authenticated data and first identifying data may correspond to fingerprint-scan, hand-scan, or iris data, as authentication process 105 can use these types of data in combination with known image matching techniques to provide a strong authentication basis and a high degree of confidence. Fundamentally, there is no limitation on the nature and character of the identifying data that first authentication process 105 can use, so long as first authentication process can compare the identifying data to authenticated data. For example, in one relatively less secure but still viable embodiment, first identifying data may be a password or physical token. First authentication process 212 of authentication system 200 may perform step 115; such a process 212 may include various comparison processes and algorithms, as known in the art.

As discussed above, first authenticated data may include an image that has been pre- authenticated for the purported registered user if the user must identify her- or himself by name or otherwise, or, if the user does not make an initial identification, the first authenticated data may include a plurality of like images corresponding to all authorized users or representations derived therefrom. Under the first scenario, i.e., wherein the user enters information identifying a registered user (which may or may not be the current user), at step 115, first authentication process 105 compares the first identifying data to the first authenticated data for the purported user to determine whether or not they match, such that the current user can be authenticated as the registered user. Under the second above scenario, first authentication process 105 may compare the first identifying data for the user to the first authenticated data for all of the authorized users to determine whether the user is one of the authorized users. In this second scenario, those skilled in the art will readily appreciate that such a comparison typically involves matching the first identifying data for the current user attempting to gain access to the device with many (e.g., hundreds, thousands, or more) sets of authenticated data corresponding to authorized users and, consequently, that in some embodiments pre-identification, such as requiring input of a registered user's name or other identifier, is desirable to avoid using too much valuable processor time.

For example, first authentication process 105 may perform iris analysis or comparison as part of step 115. In typical iris analysis, initially, system 200 performs image acquisition, which attempts to capture images of an eye of the user having sufficient quality for processing. Once system 200 acquires an iris image, for example, by means of an optical sensor, the system may segment the image in order to isolate the iris section of the eye region. For example, system 200 may identify papillary and limbic boundaries using edge detection and a Hough transform, though the system may use any known segmenting techniques. Next, system 200 may perform texture analysis on the image of the iris of the user so as to extract a representation of the iris for use in the last step, i.e., matching. In order to derive the features from a normalized iris image, system 200 may convolve the image with Gabor filters to produce a localized spatial-frequency response array, and then it may generate a binary code representation from the filter response to represent the iris image as a series of encoded bits, sometimes referred to as “the iris code.” The first bit of each two bit pair corresponds to the real part of the response and the second bit to the imaginary part. For each part, if the coefficient is positive, system 200 sets the bit to “1,” otherwise it sets it to “0.” First authentication process 105 may then measure similarity between these binary codes by calculating the normalized Hamming distance between the user's iris (i.e., the identifying data) and irises of authorized users (i.e., the authenticated data); the lower the Hamming distance, the more iris code bits are identical and, hence, the stronger the match. Those skilled in the art will readily appreciate that first authentication process 105 may perform various other known comparison processes as part of step 115.

At step 120, if the comparison between first identifying data and first authentication data determines that no match exists between the first identifying data and the first authenticated data, method 100 proceeds to step 125, at which time first authentication process 105 may deny access to the user attempting to gain access to the device or to particular functions of the device. In some embodiments, when authentication process 105 denies a user access, system 200 may lock the device or particular functions of the device for a predetermined period and/or until an administrator unlocks the device, while, in other embodiments, method 100 may immediately return to step 110 to wait for and/or continually poll for new first identifying data. However, if first authentication process 105 determines that a match exists at step 120, method 100 may hand off authentication to a second authentication process 130, such as second authentication process 216 in FIG. 2, by proceeding to step 135, at which time system 200 may iteratively generate an authentication status indicating whether or not the registered user remains present at the device.. Second authentication process 130 may compare second identifying data, such as identifying data 208, with second authenticated data, such as authenticated data 204. Again, it is important to note that although FIG. 2 represents authenticated data 204 and identifying data 208 as being outside of authentication system 200, the authentication system may store the authenticated data and/or identifying data using an appropriate computer storage system (see, e.g., FIG. 3). In some embodiments, method 100 may initiate a registered-user session when first authentication process 212 determines that a match exists at step 115; in other embodiments, method 100 may wait to initiate a registered-user session until second authentication process 130 has verified the user's identity. First authentication process 105 of authentication system 200 of FIG. 2 may perform steps 120 and 125. Second authentication process 216 may perform step 135 and may include various comparison processes and algorithms known in the art.

For example, second authentication process 130 may perform face analysis or recognition as part of step 135, which may include analyzing one or more of facial features, hairstyle, jewelry, and other aspects of the user's appearance. A training process for a face detector typically relies upon three main components. The first component, which can be important to the success of the detector, is the quality and variation represented in the training data set used to train the system. For face analysis, it is typically important that the set include faces with angular rotations, occlusions, variations in pose, illumination, and expression. A training process may use histogram equalization to scale pixel intensities such that there are an equal number of pixels at each intensity; this is the simplest way to correct for illumination variation. Other methods do more to correct for illumination but are much more computationally intensive, which quickly becomes cumbersome in a continuous-authentication setting. Not only is it important to include a large number of positive training faces, but it is also important to present the algorithm with an even larger number of negative samples, which are images that include no faces but include patterns that are similar to faces and might otherwise result in false-positives. The second component is the selection of the type of feature extraction and/or features that the classification module will utilize, and the third component is the selection of the actual pattern classification scheme that the classification module will utilize.

The training process and/or system 200 may use a face detector such as the Viola-Jones face detector, though it may utilize other face detectors, such as the Schneiderman and Kanade detector, among others. The Viola-Jones face detector is composed of a cascade of simple weak classifiers that, when combined, make a strong face detection classifier. The features used by Viola and Jones are local rectangular features, which were dubbed “Haar-like” for their resemblance to the 2D-Haar basis functions. These features capture the presence of edges, texture, and pixel intensity changes on a face. The reason these features are attractive is that they are relatively computationally efficient to calculate, particularly through a computational trick called “integral image.” With this method, the training process may obtain a response of a “Haar-like” feature in constant time regardless of the size, location, and orientation of the feature. To combine all these feature-based classifiers, Viola and Jones used the “AdaBoost” method. The AdaBoost method is an ensemble learning method that builds an accurate classifier by combining multiple weak classifiers. The Adaboost method initially assigns equal weights to all of the training samples. In each iteration, the AdaBoost method invokes a learning algorithm to find the simple classifier that minimizes the weighted classification error. The samples misclassified by the simple classifier are “up-weighted” such that in subsequent iterations the algorithm will select simple classifiers that address those errors. The final strong classifier is a linear combination of the weak classifiers where the Adaboost method assigns weights to each classifier according to its training error. Lastly, Viola and Jones split the final strong classifier learned by the AdaBoost method into a sequence of smaller classifiers. This cascaded architecture greatly contributes to the ability of their detector to run in substantially real-time. This configuration also allows for efficiently rejecting regions or “windows” in an image that do not contain a face. Since most windows will not contain faces, this greatly speeds up the process by allowing the detector more time to focus on windows with possible faces.

Second authentication process 130 may perform various other known comparison processes as part of step 135. For example, second authentication process 130 may use one or more of numerous classifiers, such as individual principal component analysis (IPCA), Fisher linear discriminant analysis (FLDA), support vector machines (SVMs), and minimum average correlation filters (MACE), among others. IPCA builds a principal component analysis (PCA) subspace for every class in the training set, projects testing images onto each subspace from every authorized person, and then reconstructs the testing images from each subspace. The reconstructed images from each subspace are then compared to the original input image, and the test image is classified based upon which subspace gives the lowest mean squared error between the original image and its reconstruction. If a sample image belongs to a particular class, its reconstruction, which is a function of a linear combination of the eigenvector basis generated from the training images of the same class, will be very similar to the original image. This yields a low mean squared error. It is often beneficial to use normalized correlation instead of mean squared error since normalized correlation is less sensitive to global illumination intensity variation.

FLDA is a class-specific method that tries to form reliable projection points for classification. FLDA generates a projection vector that maximizes inter-cluster variance, while minimizing intra-cluster variance. FLDA initially projects images onto a global principal component analysis (GPCA) subspace to reduce the dimensionality of the data, then projects these projected images into the FLDA space, creating “Fisherfaces.” GPCA is an unsupervised approach of representing faces with an eigenvector basis set called eigenfaces. The process begins with the acquisition of a training set and the calculation of a subspace that models the face variations. Later, when a FLDA receives a test face image testing, FLDA projects it into this face subspace and bases its classification upon its distance to other faces in this face subspace. The goal of FLDA is to find a projection matrix that maximizes the ratio of the inter-class scatter matrix and the intra-class scatter matrix.

SVMs attempt to find a decision boundary solution vector that maximizes the margin between two classes. SVMs are strong, supervised learning algorithms that researchers use extensively in binary classification. SVMs improve on linear discriminant analysis and neural networks by finding a hyper-plane that maximizes the projected distance between the closest elements of separate classes. SVMs may use Kernel functions to find such a hyper-plane by computing the higher-dimensional inner-product without actually finding the higher-dimensional feature mapping for every sample.

MACE seeks to minimize the average correlation energy resulting from cross- correlations with the given training images while satisfying specific linear constraints to provide a specific value at the origin of the correlation plane for each training image. Correlation filters have several properties that are advantageous in pattern recognition analyses: they are shift (i.e., translation) invariant, so it is not necessary to align the reference pattern perfectly with the observed signal, and they gracefully handle noise and occlusions.

In an exemplary embodiment, handing off authentication to second authentication process 130 may involve immediately acquiring second identifying data, for example, an image of the face of the user acquired from a built-in camera on the device, and comparing it to preexisting second authenticated data, such as a previously stored digital image of the registered user or a representation derived therefrom or other biometric data. It is noted that once second authentication process 130 verifies a user's identity as a function of second identifying data, the second authentication process may update or adjust the preexisting second authenticated data as a function of the second identifying data in order to account for temporal changes in appearance and/or other biometric qualities. In such an embodiment, it may be acceptable to use a relatively weaker authentication process/base for the first authentication process due to the usage of preexisting second authenticated data, though, after reviewing the present disclosure in its entirety, those of ordinary skill in the art will readily recognize that, in order to implement maximum security, a stronger authentication process/basis, such as iris analysis, may be used for the first authentication process in this embodiment.

In alternative embodiments, the second authentication process need not start with any preexisting second authentication data. As an example of this in which the second authentication process basis involves image matching based on continually acquired images, handing off authentication can include acquiring an initial image of the registered user and, in some embodiments, storing the initial image or a representation derived therefrom as the authenticated data. In this example, second authentication process 130 authenticates this initial image as a result of the verification of the registered user via first authentication process 105 in conjunction with the immediate acquisition of the initial image. Then, the iterative generation of step 135 may produce an authentication status, such as authentication status 220 of FIG. 2, by comparing one or more of facial features, hairstyle, jewelry, and other aspects of the user's appearance in each subsequently acquired image to the initial image of the registered user. In future user sessions, a new initial image can likewise be acquired and may either be used as authenticated data itself or may be used in combination with and/or to update or adjust previously acquired authenticated data. In such an embodiment, strong authentication bases, such as iris analysis, are best suited for use as the first authentication process due to the relative lack of security that can result from not using preexisting second authentication data.

For example, FIG. 2 depicts an example scenario 228 in which a user 232 is attempting to access a device, in this case a computer 236. A camera 240, which may or may not be integrated into computer 236, acquires images of an iris of user 232 to generate first identifying data. First authentication process 105 may compare the first identifying data corresponding to an iris of user 232 to first authenticated data corresponding to one or more irises of authorized users, and, if the first authentication process determines that a match exists, system 200 may hand off authentication to second authentication process 130. Camera 240 may then acquire images of the face of user 232 to generate second identifying data. Second authentication process 130 may then compare the second identifying data corresponding to the face of user 232 to second authenticated data corresponding to one or more faces of the user authorized by first authentication process 105. As long as second authentication process 130 finds a match between the second authenticated data and second identifying data, system 200 grants user 232 access to computer 236; as discussed above, if the user looks away from the screen for a short period and then looks back at the screen, the second authentication process may either identify the user again through second authentication process 130 or, if user 232 looked away for too long or the system cannot identify the user, second authentication process 130 may deny the user access and the system may require the user to re-authenticate through first authentication process 105. It is important to note that although FIG. 2 represents authentication system 200, authenticated data 204, and identifying data 208 as being outside of computer 236 in FIG. 2, computer 236 (or any other device) may include authentication system 200 and may store authenticated data 204 and/or identifying data 208 using an appropriate computer storage system (see, e.g., FIG. 3); on the other hand, authentication system 200, authenticated data 204, and identifying data 208 may be external to computer 236 (or other device) and connected through a network or other means known in the art.

Keystroke-pattern analysis, face comparison analysis, and fingerprint analysis can be particularly well-suited for use as the basis or one of the bases of the second authentication process, because, under certain conditions, they can be performed in a transparent fashion relative to the user, though it is noted that keystroke-pattern analysis and fingerprint analysis require continuous typing or fingerprint readings, respectively, in order to be used in a continuous authentication system according to the present disclosure. Ideally, there should be no notable differences in the behavior or usability of the workstation as a result of the iterative, continuous authentication. Because a method of controlling a registered-user session of a registered user may run as a background process on the same machine that services the user's other processes, in certain embodiments, it may be necessary to implement such transparency by using minimal memory and CPU usage and obtaining biometric samples without requiring any special cooperation or actions from the user. Although heavy use of computing resources allows for more-accurate algorithms, if they monopolize the CPU, they may inconvenience authorized users and/or decrease their productivity. In the case that an authentication system according to the invention is implemented using a multi-core CPU, one core may be dedicated to continuous authentication without blocking the flow of execution of the user's other processes.

As indicated above, second authentication process 130 may iteratively generate an authentication status, such as authentication status 220 of FIG. 2, then, depending on the authentication status, method 100 may proceed to step 145, at which time a session controller 224 of authentication system 200 may control the session. In an exemplary embodiment, second authentication process 130 may generate a new or updated authentication status twelve times per second so as to indicate whether the registered user authenticated by first authentication process 105 remains present at the device. If the one or more authentication statuses indicates that the registered user is not present at the device for a certain period of time, session controller 224 may block access to the device until the user's identity is re-confirmed (or the identity of another registered user is confirmed) by first authentication process 105. If only a short amount of time (sometimes referred to as a “grace” period), typically on the order of seconds, passes before the user re-authenticates, system 200 may attempt to verify the user's identity on the basis of second authentication process 130. If more time has passed or the system cannot identify the user, second authentication process 130 may deny the user access and the system may require the user to re-authenticate through first authentication process 105. System 200 may make use of an adjustable parameter, which may be adjustable by registered users or, in some cases, only by an administrator, to control the length of this grace period, which, in some embodiments, may be configured to last indefinitely or to last for a predetermined extended period, such as twenty-four hours or more. For example, if a registered user authenticated by the first authentication process 105 leaves the device and an unauthorized user attempts to access the device, system 200 will deny them access. However, when the registered user authenticated by the first authentication process 105 returns, if the grace period has not elapsed, system 200 may re-authenticate the registered user's identity on the basis of second authentication process 130. In some embodiments, aspects of the present disclosure may be implemented by or in conjunction with a screen saver triggered by a period of inactivity.

The basis or bases of second authentication process 130 may be different from the basis or bases of first authentication process 105. For example, a face analysis offering a strong authentication basis and a high degree of confidence, but which uses high amounts of memory or CPU, may be used for first authentication process 105, while a face analysis with a weaker authentication basis and lower degree of confidence may be used for second authentication process 130. In other embodiments, the first and second authentication processes 105, 130 may use the same basis, such as a high-quality fingerprint analysis. After reviewing the present disclosure in its entirety, those of ordinary skill in the art will readily recognize the vast number of permutations of different bases that can be used for the first and second authentication processes, including bases of different types and strengths; this is particularly so in view of the fact that multiple separate bases can be used as a basis in a single authentication process. For example, iris and fingerprint analysis may together form the basis of the first authentication process, while face and keystroke-pattern analysis may together form the basis of the second authentication process.

FIG. 3 shows a diagrammatic representation of one embodiment of a computer in the exemplary form of a computing system 300 that contains a set of instructions for implementing any one or more of the aspects and/or methodologies of the present disclosure, including implementing method 100 and/or any of the other methods of the present disclosure, or portion(s) thereof. Computing system 300 includes a processor 304 and a memory 308 that communicate with each other, and with other components, via a bus 312. Bus 312 may include any of several types of bus structures including, but not limited to, a memory bus, a memory controller, a peripheral bus, a local bus, and any combinations thereof, using any of a variety of bus architectures.

Memory 308 may include various components (e.g., machine readable media) including, but not limited to, a random access memory component (e.g., a static RAM “SRAM”, a dynamic RAM “DRAM”, etc.), a read only component, and any combinations thereof. In one example, a basic input/output system 316 (BIOS), including basic routines that help to transfer information between elements within computing system 300, such as during start-up, may be stored in memory 308. Memory 308 may also include (e.g., stored on one or more machine-readable storage media) instructions (e.g., software) 320 embodying any one or more of the aspects and/or methodologies of the present disclosure. In another example, memory 308 may further include any number of program modules including, but not limited to, an operating system, one or more application programs, other program modules, program data, and any combinations thereof.

Computing system 300 may also include a storage device 324. Examples of a storage device (e.g., storage device 324) include, but are not limited to, a hard disk drive for reading from and/or writing to a hard disk, a magnetic disk drive for reading from and/or writing to a removable magnetic disk, an optical disk drive for reading from and/or writing to an optical medium (e.g., a CD, a DVD, etc.), a solid-state memory device, and any combinations thereof. Storage device 324 may be connected to bus 312 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 324 (or one or more components thereof) may be removably interfaced with computing system 300 (e.g., via an external port connector (not shown)). Particularly, storage device 324 and an associated machine-readable storage medium 328 may provide nonvolatile and/or volatile storage of machine-readable instructions, data structures, program modules, and/or other data for computing system 300. In one example, software 320 may reside, completely or partially, within machine-readable storage medium 328. In another example, software 320 may reside, completely or partially, within processor 304. It is noted that the term “machine-readable storage medium” does not include signals present on one or more carrier waves.

Computing system 300 may also include an input device 332. In one example, a user of computing system 300 may enter commands and/or other information into computing system 300 via input device 332. Examples of an input device 332 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), touchscreen, and any combinations thereof. Input device 332 may be interfaced to bus 312 via any of a variety of interfaces (not shown) including, but not limited to, a serial interface, a parallel interface, a game port, a USB interface, a FIREWIRE interface, a direct interface to bus 312, and any combinations thereof. Input device 332 may include a touch screen interface that may be a part of or separate from display 336, discussed further below. Input device 332 may be utilized as a user selection device for selecting one or more graphical representations in a graphical interface as described above.

A user may also input commands and/or other information to computing system 300 via storage device 324 (e.g., a removable disk drive, a flash drive, etc.) and/or network interface device 340. A network interface device, such as network interface device 340 may be utilized for connecting computing system 300 to one or more of a variety of networks, such as network 344, and one or more remote devices 348 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 344, may employ a wired and/or a wireless mode of communication. In general, any network topology may be used. Information (e.g., data, software 320, etc.) may be communicated to and/or from computing system 300 via network interface device 340.

Computing system 300 may further include a video display adapter 352 for communicating a displayable image to a display device, such as display device 336. Examples of a display device include, but are not limited to, a liquid crystal display (LCD), a cathode ray tube (CRT), a plasma display, a light emitting diode (LED) display, and any combinations thereof. In addition to a display device, a computing system 300 may include one or more other peripheral output devices including, but not limited to, an audio speaker, a printer, and any combinations thereof. Such peripheral output devices may be connected to bus 312 via a peripheral interface 356. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments of the system and method of the present invention, what has been described herein is merely illustrative of the application of the principles of the present invention.

What is claimed is:

1. A method of controlling a registered-user session of a registered user, wherein the registered-user session is conducted on a device, the method being performed by an authentication system and comprising:
performing a first authentication process so as to authenticate the registered user, wherein the first authentication process has a first basis and includes:
receiving first identifying data associated with the registered user; and
comparing the first identifying data to first authenticated data so as to determine whether a match exists between the first identifying data and the first authenticated data; and
if a match is determined to exist based on said comparing, then:
handing off authentication to a second authentication process having a second basis different from the first basis;
iteratively generating an authentication status indicating whether or not the registered user remains present at the device; and
controlling the session as a function of the authentication status.

2. A method according to claim 1, wherein said handing off authentication includes performing the second authentication process immediately after the first authentication process.

3. A method according to claim 2, wherein said handing off authentication further includes acquiring initial second identifying data.

4. A method according to claim 3, wherein said handing off authentication further includes updating second authenticated data as a function of initial second identifying data and said iteratively generating an authentication status includes comparing subsequent second identifying data to the second authenticated data.

5. A method according to claim 3, wherein the first authentication process includes biometric analysis.

6. A method according to claim 2, wherein said handing off authentication further includes acquiring initial second identifying data and comparing it to pre-stored second authenticated data.

7. A method according to claim 1, wherein the second authentication process includes image matching.

8. A method according to claim 1, wherein the device is a computing device.

9. A method according to claim 8, wherein the second authentication process includes image matching.

10. A method according to claim 9, wherein the first authentication process includes biometric analysis.

11. A method according to claim 1, further comprising starting a registered-user session when a match is determined to exist based on said comparing.

12. A method according to claim 1, wherein said iteratively generating an authentication status includes generating an authentication status at least twelve times per second.

13. A method according to claim 1, wherein said controlling the session includes terminating the session as a function of a duration of time in which the authentication status indicates that the registered user is not present at the device.

14. A machine-readable storage medium containing machine executable instructions for performing a method of controlling a registered-user session of a registered user, wherein the registered-user session is conducted on a device, said machine-executable instructions comprising:
a first set of machine-executable instructions for performing a first authentication process so as to authenticate the registered user, wherein the first authentication process has a first basis and said first set of machine-executable instructions includes machine-executable instructions for:
receiving first identifying data associated with the registered user; and
comparing the first identifying data to first authenticated data so as to determine whether a match exists between the first identifying data and the first authenticated data; and
a second set of machine-executable instructions for determining whether a match exists based on said comparing, and, if a match is determined to exist, for:
handing off authentication to a second authentication process having a second basis different from the first basis;
iteratively generating an authentication status indicating whether or not the registered user remains present at the device; and
controlling the session as a function of the authentication status.

15. A machine-readable storage medium according to claim 14, wherein said second set of machine-executable instructions includes machine-executable instructions for performing the second authentication process immediately after the first authentication process.

16. A machine-readable storage medium according to claim 15, wherein said second set of machine-executable instructions includes machine-executable instructions for acquiring initial second identifying data.

17. A machine-readable storage medium according to claim 16, wherein said second set of machine-executable instructions includes machine-executable instructions for updating second authenticated data as a function of initial second identifying data and comparing subsequent second identifying data to the second authenticated data.

18. A machine-readable storage medium according to claim 16, wherein said first set of machine-executable instructions includes machine-executable instructions for performing biometric analysis.

19. A machine-readable storage medium according to claim 15, wherein said second set of machine-executable instructions includes machine-executable instructions for acquiring initial second identifying data and comparing it to pre-stored second authenticated data.

20. A machine-readable storage medium according to claim 14, wherein said second set of machine-executable instructions includes machine-executable instructions for performing image matching.

21. A machine-readable storage medium according to claim 14, wherein the device is a computing device.

22. A machine-readable storage medium according to claim 21, wherein said second set of machine-executable instructions includes machine-executable instructions for performing image matching.

23. A machine-readable storage medium according to claim 22, wherein said first set of machine-executable instructions includes machine-executable instructions for performing biometric analysis.

24. A machine-readable storage medium according to claim 14, further comprising a third set of machine-executable instructions for starting a registered-user session when a match is determined to exist based on said comparing.

25. A machine-readable storage medium according to claim 14, wherein said second set of machine-executable instructions includes machine-executable instructions for generating an authentication status at least twelve times per second.

26. A machine-readable storage medium according to claim 14, wherein said second set of machine-executable instructions includes machine-executable instructions for controlling the session by terminating the session as a function of a duration of time in which the authentication status indicates that the registered user is not present at the device.
